(19) United States
(12) Patent Application Publication
(10) Pub. No.: US 2024/0063916 A1
(43) Pub. Date: Feb. 22, 2024

(54) OPTICAL TRANSMITTING APPARATUS, OPTICAL TRANSMITTING METHOD, AND OPTICAL TRANSMISSION SYSTEM

(71) Applicant: NIPPON TELEGRAPH AND TELEPHONE CORPORATION, Tokyo (JP)

(72) Inventors: Toshiaki SHITABA, Musashino-shi, Tokyo (JP); Akihiro TANABE, Musashino-shi, Tokyo (JP); Yoichi FUKADA, Musashino-shi, Tokyo (JP); Ryo MIYATAKE, Musashino-shi, Tokyo (JP)

(73) Assignee: NIPPON TELEGRAPH AND TELEPHONE CORPORATION, Tokyo (JP)

(21) Appl. No.: 18/270,537

(22) PCT Filed: Jan. 4, 2021
(86) PCT No.: PCT/JP2021/000005

§ 371 Date: Jun. 30, 2023

(51) Int. Cl. H04B 10/548; H04B 10/50

(52) U.S. Cl. CPC H04B 10/548; H04B 10/503

(57) ABSTRACT

An optical transmission apparatus includes:
a distribution unit configured to distribute a modulation signal to a plurality of amplification units connected in parallel; a plurality of phase modulators which are connected in cascade to generate a phase-modulated optical signal in accordance with each modulation signal of which voltage is amplified by the plurality of amplification units connected in parallel by using a laser beam based on a first oscillation frequency; a multiplexing unit configured to multiplex a laser beam based on a second oscillation frequency and the optical signal; and a detection unit configured to generate a frequency modulation signal by executing detection processing on a result of multiplexing the laser beam based on the second oscillation frequency and the optical signal.

### TECHNICAL FIELD

The present invention relates to an optical transmission apparatus, an optical transmission method, and an optical transmission system.

### BACKGROUND ART

An optical transmission system of a scheme (hereinafter, it is referred to as an “FM batch conversion method”) for collectively converting a frequency division multiplexing (FDM) signal into a frequency modulation (FM) signal is introduced into a video signal distribution system (see Non Patent Documents 1 and 2).

FIG. 4 is a diagram illustrating a first example of a configuration of a frequency modulation unit provided in an optical transmission apparatus of such an optical transmission system. The frequency modulation unit 100 includes a first laser oscillator 101, a second laser oscillator 102, a phase modulator 103, a multiplexing unit 104, and a detection unit 105.

The first laser oscillator 101 is a laser diode. The first laser oscillator 101 generates a laser beam based on the first oscillation frequency “f1.” A video signal (modulation signal) of cable television broadcasting in a frequency multiplexed signal is input into the first laser oscillator 101 from a head end apparatus (not shown). The first laser oscillator 101 generates an optical signal directly modulated in accordance with a video signal of cable television broadcasting by using a laser beam based on the first oscillation frequency “f1.”

The second laser oscillator 102 is a laser diode. The second laser oscillator 102 generates a laser beam based on the second oscillation frequency “f2.” Hereinafter, the video signal whose phase is inverted is referred to as an “opposite-phase video signal.” An opposite-phase video signal of cable television broadcasting in the frequency multiplexed signal is input into the second laser oscillator 102 from a head end apparatus (not shown). The first laser oscillator 101 generates an optical signal directly modulated in accordance with an opposite-phase video signal by using a laser beam based on the second oscillation frequency “f2.”

An optical signal directly modulated in accordance with a video signal of cable television broadcasting is input into the phase modulator 103 from the first laser oscillator 101. Moreover, a video signal (modulation signal) of satellite broadcasting in the frequency multiplexed signal is input into the phase modulator 103 from a head end apparatus (not shown).

The phase modulator 103 modulates a phase of an optical signal directly modulated in accordance with a video signal of cable television broadcasting in accordance with a video signal of satellite broadcasting. The phase modulator 103 outputs the phase-modulated optical signal to the multiplexing unit 104.

The phase-modulated optical signal is input into the multiplexing unit 104 from the phase modulator 103. Furthermore, an optical signal directly modulated in accordance with the opposite-phase video signal is input into the multiplexing unit 104 from the second laser oscillator 102. The multiplexing unit 104 multiplexes the phase-modulated optical signal and the optical signal directly modulated in accordance with the opposite-phase video signal.

The detection unit 105 executes batch reception processing (optical heterodyne detection) on the multiplexed optical signal by using the photodiode. Accordingly, the detection unit 105 generates a frequency modulation signal having high linearity. The center frequency of this frequency modulation signal is “|f1−f2|.”

### CITATION LIST

### Non Patent Literature

Non Patent Literature 1; ITU-T J.185: Transmission equipment for transferring multi-channel television signals over optical access networks by frequency modulation conversion, [online], [retrieved on Dec. 21, 2020], Internet <URL: https://www.itu.int/rec/T-REC-J.185-201206-I/en>
Non Patent Literature 2: Toshiaki Shimoha and two others, “optical video distribution technology using FM collective conversion method,” IEICE Technical Report IEICE Technical Report CS2019-84, IE2019-64(2019-12), [online], [retrieved on Dec. 21, 2020], Internet <URL: https://www.ieice.org/ken/paper/20191206T1TI/>

### SUMMARY OF INVENTION

### Technical Problem

In the FM collective conversion method, the frequency modulation unit generates an optical signal directly modulated in accordance with an input video signal (modulation signal) by using two laser beams. The characteristics between the bias current and the oscillation frequency in the two laser beams are required to have very high linearity. Therefore, there is a problem that the selection cost of each laser oscillator is very high. In order to solve this problem, it is conceivable that a phase modulator is connected to a subsequent stage of one laser oscillator of the two laser oscillators, and then all the video signals to be transmitted are input into the phase modulator.

FIG. 5 is a diagram illustrating a second example of a configuration of a frequency modulation unit provided in an optical transmission apparatus of the optical transmission system. A frequency modulation unit 110 includes a first laser oscillator 111, a second laser oscillator 112, a phase modulator 113, a multiplexing unit 114, a detection unit 115, and an amplification unit 116.

The first laser oscillator 111 generates a laser beam based on the first oscillation frequency “f1.” The first laser oscillator 111 outputs, to the phase modulator 113, a laser beam based on the first oscillation frequency “f1.” The second laser oscillator 112 generates a laser beam based on the second oscillation frequency “f2.” The second laser oscillator 112 outputs, to the multiplexing unit 114, a laser beam based on the second oscillation frequency “f2.”

A video signal of cable television broadcasting and a video signal of satellite broadcasting are input as frequency multiplexed signals from a head end apparatus (not shown) to the amplification unit 116. The amplification unit 116 amplifies the voltages of these video signals to about several volts in order to obtain a sufficient frequency shift amount in the frequency modulation signal. The amplification unit 116 outputs the video signal of which the voltage is amplified to a phase modulator 113.

The phase modulator 113 generates a phase-modulated optical signal using the video signal of which the voltage is amplified by using the laser beam based on the first oscillation frequency “f1.” The phase-modulated optical signal is input into the multiplexing unit 114 from the phase modulator 113. Moreover, a laser beam based on the second oscillation frequency “f2” is input into the multiplexing unit 114 from the second laser oscillator 112.

The multiplexing unit 114 multiplexes the phase-modulated optical signal and the laser beam based on the second oscillation frequency “f2.” The detection unit 115 executes batch reception processing (optical heterodyne detection) on the multiplexed optical signal by using the photodiode.

However, in the frequency modulation unit 110, since the signal quality is deteriorated due to distortion caused in the video signal in the amplification unit 116, distortion characteristics may be not improved.

In view of the above circumstances, an object of the present invention is to provide an optical transmission apparatus, an optical transmission method, and an optical transmission system capable of improving distortion characteristics.

### Solution to Problem

One aspect of the present invention is an optical transmission apparatus including: a distribution unit configured to distribute a modulation signal to a plurality of amplification units connected in parallel; a plurality of phase modulators which are connected in cascade to generate a phase-modulated optical signal in accordance with each modulation signal of which voltage is amplified by the plurality of the amplification units connected in parallel by using a laser beam based on a first oscillation frequency; a multiplexing unit configured to multiplex a laser beam based on a second oscillation frequency and the optical signal; and
a detection unit configured to generate a frequency modulation signal by executing detection processing on a result of multiplexing the laser beam based on the second oscillation frequency and the optical signal.

One aspect of the present invention is an optical transmission method executed by an optical transmission apparatus, and the method includes:
a distribution step of distributing a modulation signal to a plurality of amplification units connected in parallel; a plurality of phase modulation steps of generating a phase-modulated optical signal in accordance with each modulation signal of which voltage is amplified by the plurality of the amplification units connected in parallel using a laser beam based on a first oscillation frequency in a plurality of phase modulators connected in cascade; a multiplexing step of multiplexing a laser beam based on a second oscillation frequency and the optical signal; and a detection step of generating a frequency modulation signal by executing detection processing on a result of multiplexing the laser beam based on the second oscillation frequency and the optical signal.

One aspect of the present invention is an optical transmission system including an optical transmission apparatus, an optical line terminal, and an optical line end terminal, in which the optical transmission apparatus includes: a distribution unit configured to distribute a modulation signal to a plurality of amplification units connected in parallel;
a plurality of phase modulators which are connected in cascade to generate a phase-modulated first optical signal in accordance with each modulation signal of which voltage is amplified by the plurality of amplification units connected in parallel by using a laser beam based on a first oscillation frequency; a multiplexing unit configured to multiplex a laser beam based on a second oscillation frequency and the first optical signal; a detection unit configured to generate a frequency modulation signal by executing detection processing on a result of multiplexing the laser beam based on the second oscillation frequency and the first optical signal; and an intensity modulator configured to generate an intensity-modulated second optical signal by using a laser beam for transmission by executing intensity modulation in accordance with the frequency modulation signal, in which the optical line terminal transmits the intensity-modulated second optical signal, and the optical line end terminal acquires the intensity-modulated second optical signal.

### Advantageous Effects of Invention

According to the present invention, distortion characteristics can be improved.

### BRIEF DESCRIPTION OF DRAWINGS

FIG. 1 is a diagram illustrating a configuration example of an optical transmission system according to an embodiment.

FIG. 2 is a diagram illustrating a configuration example of a frequency modulation unit according to an embodiment.

FIG. 3 is a flowchart illustrating an operation example of the frequency modulation unit according to an embodiment.

FIG. 4 is a diagram illustrating a first example of a configuration of the frequency modulation unit provided in the optical transmission apparatus of the optical transmission system.

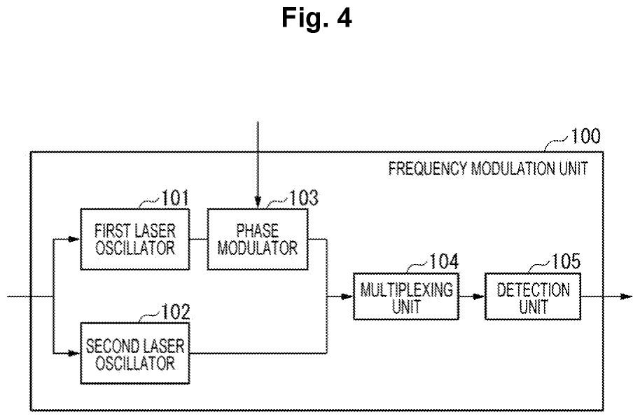

FIG. 5 is a diagram illustrating a second example of a configuration of the frequency modulation unit provided in an optical transmission apparatus of an optical transmission system.

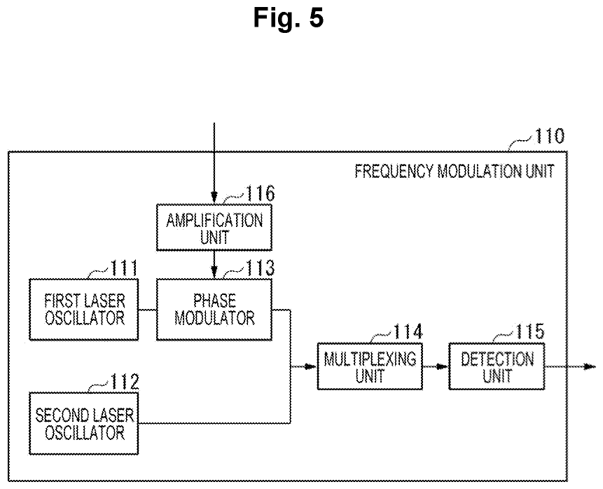

### DESCRIPTION OF EMBODIMENTS

Embodiments of the present invention will be described in detail with reference to the drawings.

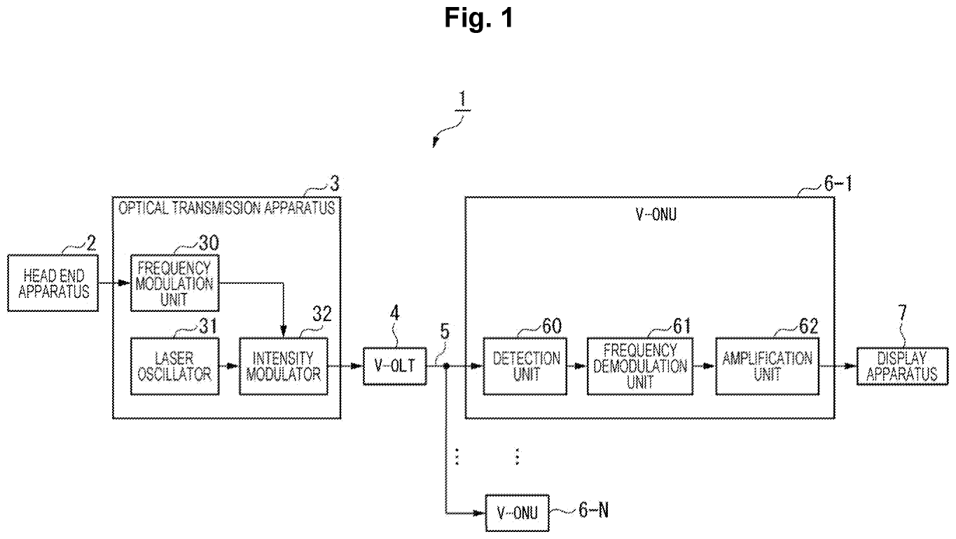

FIG. 1 is a diagram illustrating a configuration example of an optical transmission system 1. The optical transmission system 1 is a system (optical transmission network) that transmits an optical signal. Hereinafter, as an example, the optical transmission system 1 distributes a video signal by using an optical signal. The video may be a moving image or a still image.

The optical transmission system 1 includes a head end apparatus 2, an optical transmission apparatus 3, a V-OLT 4, a transmission path 5, N (N is an integer of 1 or more) V-ONUs 6, and a display apparatus 7. The optical transmission apparatus 3 includes a frequency modulation unit 30, a laser oscillator 31, and an intensity modulator 32. The V-ONU 6 includes a detection unit 60, a frequency demodulation unit 61, and an amplification unit 62.

The head end apparatus 2 outputs a frequency multiplexed signal including a video signal (modulation signal) to the optical transmission apparatus 3. Note that the head end apparatus 2 may output a frequency multiplexed signal including an audio signal, a data signal (modulation signal), and the like and a video signal to the optical transmission apparatus 3.

The optical transmission apparatus 3 is an apparatus that transmits an optical signal. The frequency modulation unit 30 executes, for example, optical heterodyne detection processing on an optical beat between an optical signal subjected to phase-modulation in accordance with a video signal and an optical signal subjected to phase-modulation in accordance with a video signal having an opposite phase. Thus, the frequency modulation unit 30 generates a frequency modulation signal (FM signal).

The laser oscillator 31 generates a laser beam for transmission based on a predetermined oscillation frequency. The intensity modulator 32 is a device that executes intensity modulation on a laser beam for transmission in accordance with a frequency modulation signal. The intensity modulator 32 generates an intensity-modulated optical signal by using a laser beam for transmission. The intensity modulator 32 transmits the intensity-modulated optical signal to the V-OLT 4.

A video-optical line terminal 4 (V-OLT 4) is an optical line terminal. The V-OLT 4 transmits the optical signal intensity-modulated by the intensity modulator 32 to each V-ONU 6 via the transmission path 5. The transmission path 5 transmits an optical signal by using an optical fiber. The transmission path 5 uses an optical splitter to distribute an optical signal to each V-ONU 6 from the V-ONU 6-1 to the V-ONU 6-N.

The video-optical network unit 6 (V-ONU 6) is an optical line end terminal. The detection unit 60 includes a photodiode. The detection unit 60 converts the optical signal acquired via the transmission path 5 into a frequency modulation signal (electric signal). The frequency demodulation unit 61 generates a frequency multiplexed signal including a video signal by executing demodulation processing on the frequency modulation signal. The demodulation processing includes processing of detecting a rise of the frequency modulation signal and processing of detecting a fall of the frequency modulation signal. The amplification unit 62 amplifies the voltage of the video signal in the frequency multiplexed signal to a predetermined level.

The display apparatus 7 is an apparatus that displays a video on a screen. The display apparatus 7 acquires, from the amplification unit 62, a frequency multiplexed signal including a video signal of which voltage has been amplified to a predetermined level. The display apparatus 7 displays the video on the screen in accordance with the video signal in the frequency multiplexed signal.

Next, a configuration example of the frequency modulation unit 30 will be described.

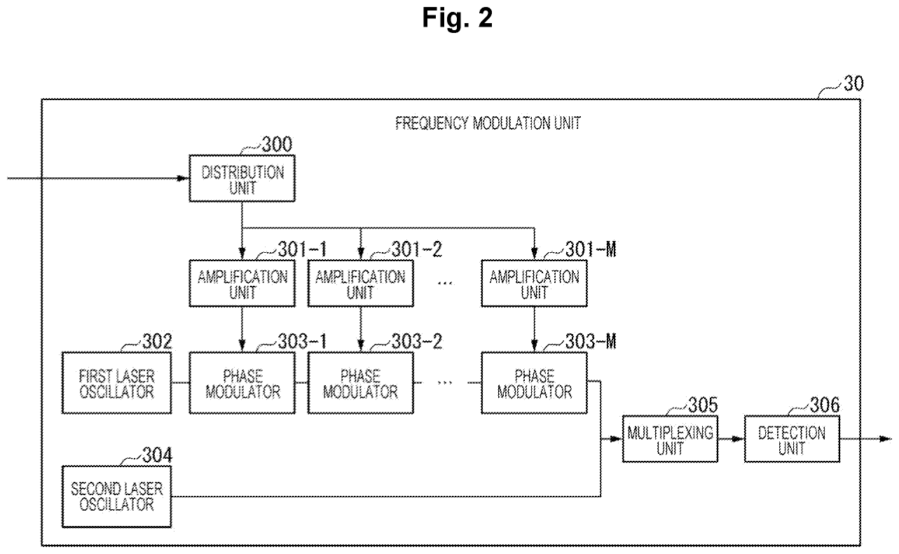

FIG. 2 is a diagram illustrating a configuration example of the frequency modulation unit 30. The frequency modulation unit 30 includes a distribution unit 300, M (M is an integer of 2 or more) amplification units 301, a first laser oscillator 302, M phase modulators 303, a second laser oscillator 304, a multiplexing unit 305, and a detection unit 306. “M” is determined, for example, on the basis of a simulation result or an experimental result regarding the specification.

In FIG. 2, the amplification unit 301-m (m is an integer from 1 to M) is connected to the phase modulator 303-m such that the output of the amplification unit 301-m is input into the phase modulator 303-m. As described above, the frequency modulation unit 30 includes a combination of the amplification unit 301-m m and the phase modulator 303-m.

The M phase modulators 303 are cascade-connected at the subsequent stage of the first laser oscillator 302. That is, the preceding phase modulator 303 and the subsequent phase modulator 303 are connected such that the output of the preceding phase modulator 303 is input into the subsequent phase modulator 303.

A frequency multiplexed signal including a video signal (modulation signal) is input into the distribution unit 300 from the head end apparatus 2 as an input signal. Hereinafter, the video signal is, for example, a video signal of cable television broadcasting and a video signal of satellite broadcasting (intermediate frequency (IF) signal).

A video signal of cable television broadcasting is, for example, an amplitude modulation (AM) signal for analog broadcasting and a quadrature amplitude modulation (QAM) signal for digital broadcasting, which are included in a band, for example, from 70 MHz to 770 MHz. A video signals of satellite broadcasting is, for example, a broadcast satellite (BS) signal and a communication satellite (CS) signal of 110 degrees included in a band from 1.0 GHz to 2.1 GHz.

The distribution unit 300 distributes (frequency distribution) the frequency multiplexed signal including the video signal (modulation signal) to the M amplification units 301. Each distributed video signal is input from the distribution unit 300 to each amplification unit 301. The amplification unit 301 amplifies the voltage (amplitude) of the input video signal to a predetermined level. Herein, the voltage of the video signal (modulation signal) input into each of the plurality of amplification unit 301 can be made lower than the voltage of the video signal input into the single amplification unit.

The amplification unit 301 outputs the video signal, of which the voltage is amplified, to the phase modulator 303 connected to the own amplification unit among M phase modulators 303. For example, the amplification unit 301-1 outputs the video signal, of which the voltage is amplified, to the phase modulator 303-1. For example, the amplification unit 301-M outputs the video signal, of which the voltage is amplified, to the phase modulator 303-M.

The first laser oscillator 302 is a laser diode. The first laser oscillator 302 generates a laser beam based on the first oscillation frequency “f1.” The first laser oscillator 302 outputs a laser beam based on the first oscillation frequency “f1” to the phase modulator 303-1.

A video signal (modulation signal) of which the voltage is amplified is input into the phase modulator 303-m from the amplification unit 301-m connected to the own phase modulator.

A laser beam based on the first oscillation frequency “f1” is input into the phase modulator 303-1 from the first laser oscillator 302. The phase modulator 303-1 generates a phase-modulated optical signal in accordance with the video signal, of which the voltage is amplified, by using the laser beam based on the first oscillation frequency “f1.” The phase modulator 303-1 outputs, to the phase modulator 303-2, a phase-modulated optical signal in accordance with the video signal of which voltage is amplified.

The phase modulator 303-(m−1) (this “m” is an integer from 3 to M) generates a phase-modulated optical signal in accordance with the video signal, of which the voltage is amplified, by using the optical signal output from phase modulator 303-(m−2). The phase modulator 303-(m−1) outputs, to the phase modulator 303-m, a phase-modulated optical signal in accordance with the video signal of which voltage is amplified.

The phase modulator 303-M generates a phase-modulated optical signal in accordance with the video signal of which the voltage is amplified by using the optical signal output from the phase modulator 303-(M−1). The phase modulator 303-M outputs, to the multiplexing unit 305, a phase-modulated optical signal in accordance with the video signal of which the voltage is amplified.

The second laser oscillator 304 is a laser diode. The second laser oscillator 304 generates a laser beam based on the second oscillation frequency “f2.” The second laser oscillator 304 outputs, to the multiplexing unit 305, a laser beam based on the second oscillation frequency “f2.”

The phase-modulated optical signal in accordance with the video signal is input into the multiplexing unit 305 from the phase modulator 303-M. Moreover, a laser beam based on the second oscillation frequency “f2” is input into the multiplexing unit 305 from the second laser oscillator 304. The multiplexing unit 305 multiplexes the phase-modulated optical signal in accordance with the video signal and the laser beam based on the second oscillation frequency “f2.” The multiplexing unit 305 outputs the multiplexed optical signal to the detection unit 306.

The detection unit 306 includes a photodiode. The detection unit 306 executes batch reception processing (e.g., optical heterodyne detection processing) on the multiplexed optical signal by using the photodiode. Thus, the detection unit 306 generates a frequency modulation signal (FM signal). The detection unit 306 outputs a wide-band (e.g., from 500 MHz to 6 GHz) frequency modulation signal to the intensity modulator 32.

Next, an operation example of the frequency modulation unit 30 will be described.

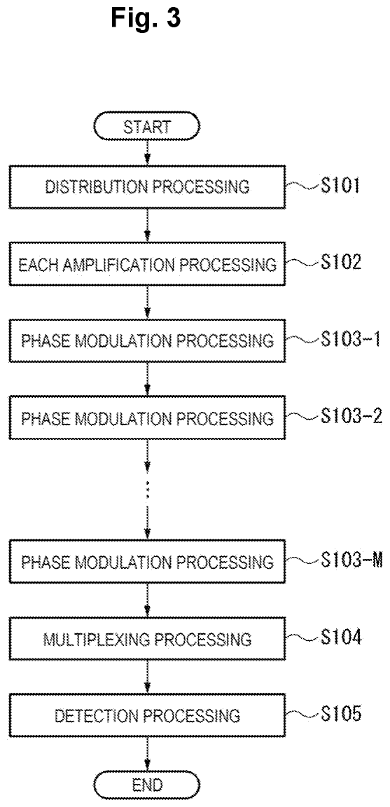

FIG. 3 is a flowchart illustrating an operation example of the frequency modulation unit 30. The distribution unit 300 outputs the video signals (modulation signals) to the plurality of amplification units 301 by distribution processing on the input signals (step S101).

Each amplification unit 301 amplifies the voltage of the video signal input into the own amplification unit to a predetermined level. Each amplification unit 301 outputs the video signal of which the voltage is amplified to the phase modulator 303 connected to the own amplification unit among the M phase modulators 303 (step S102).

The phase modulator 303-1 generates a phase-modulated optical signal in accordance with the video signal, of which the voltage is amplified, by using the laser beam based on the first oscillation frequency “f1.” The phase modulator 303-1 outputs, to the phase modulator 303-2, a phase-modulated optical signal in accordance with the video signal of which voltage is amplified (step S103-1).

The phase modulator 303-(m−1) (this “m” is an integer from 3 to M) generates a phase-modulated optical signal in accordance with the video signal, of which the voltage is amplified, by using the optical signal output from phase modulator 303-(m−2). The phase modulator 303-(m−1) outputs, to the phase modulator 303-m, a phase-modulated optical signal in accordance with the video signal of which the voltage is amplified (step S103-m).

The phase modulator 303-M generates a phase-modulated optical signal in accordance with the video signal of which the voltage is amplified by using the optical signal output from the phase modulator 303-(M−1). The phase modulator 303-M outputs, to the multiplexing unit 305, a phase-modulated optical signal in accordance with the video signal of which the voltage is amplified (step S103-M).

The multiplexing unit 305 multiplexes the phase-modulated optical signal in accordance with the video signal and the laser beam based on the second oscillation frequency “f2” (step S104) The detection unit 306 generates a frequency modulation signal by executing batch reception processing on a result obtained by multiplexing the phase-modulated the optical signal in accordance with the video signal and the laser beam based on the second oscillation frequency “f2” (step S105).

As described above, the distribution unit 300 distributes the modulation signal to the plurality of amplification units 301 connected in parallel. The plurality of amplification units 301 connected in parallel amplifies the voltage of each modulation signal. The plurality of phase modulators 303 connected in cascade generates, by using a laser beam based on the first oscillation frequency “f1,” a phase-modulated optical signal (first optical signal) in accordance with each modulation signal of which the voltage is amplified. The multiplexing unit 305 multiplexes the laser beam based on the second oscillation frequency “f2” and the phase-modulated optical signal (first optical signal). The detection unit 306 generates a frequency modulation signal by executing detection processing on a result of multiplexing the laser beam based on the second oscillation frequency and the optical signal subjected to phase modulation. The detection unit 306 generates a frequency modulation signal (FM signal) by executing detection processing (e.g., optical heterodyne detection processing) on a result of multiplexing the laser beam based on the second oscillation frequency “f2” and the optical signal (first optical signal) subjected to phase modulation. The intensity modulator 32 executes intensity modulation in accordance with the frequency modulation signal to generate an intensity-modulated optical signal (second optical signal) by using a laser beam for transmission. The optical line terminal 4 (V-OLT 4) transmits an intensity-modulated optical signal (second optical signal). The optical line end terminal (V-ONU 6) acquires an intensity-modulated optical signal (second optical signal).

Herein, since the voltage of the video signal (modulation signal) input into each of the plurality of amplification units 301 can be lower than the voltage of the video signal input into the single amplification unit, the distortion occurred in the video signal in the combination of the plurality of amplification units 301 is smaller than the distortion occurred in the video signal in the single amplification unit. Moreover, since the voltage of the video signal (modulation signal) input into each of the plurality of phase modulators 303 (optical phase modulators) can be lower than the voltage of the video signal input into the single phase modulator, the distortion occurred in the video signal in the combination of the plurality of phase modulators 303 is smaller than the distortion occurred in the video signal in the single phase modulator.

Thus, distortion characteristics can be improved in an optical transmission system that generates a frequency modulation signal by using an optical beat.

As described above, in the FM collective conversion method excellent in distortion characteristics, since the voltages of the video signals input into the plurality of phase modulators 303 can be lowered, distortion occurred in the video signals in the plurality of phase modulators 303 can be suppressed to be small. Therefore, even when the voltage of the video signal input to each of the plurality of phase modulators 303 increases in accordance with channel addition, band increase, or the like, the quality of the video signal is less likely to deteriorate.

Some or all of the functional units of the optical transmission system 1 are realized as software by causing a processor such as a central processing unit (CPU) to execute a program stored in a storage device including a non-volatile recording medium (non-transitory recording medium) and a memory. The program may be recorded on a computer-readable recording medium. The computer-readable recording medium is, for example, a portable medium such as a flexible disk, a magneto-optical disk, a read-only memory (ROM), or a compact disc read-only memory (CD-ROM), or a non-transitory recording medium such as a storage device such as a hard disk built in a computer system.

Some or all of the functional units of the optical transmission system 1 may be realized by using hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention is applicable to a video distribution system.

### REFERENCE SIGNS LIST

1 Optical transmission system
2 Head end apparatus
3 Optical transmission apparatus
4 V-OLT
5 Transmission path
6 V-ONU
7 Display apparatus
30 Frequency modulation unit
31 Laser oscillator
32 Intensity modulator
60 Detection unit
61 Frequency demodulation unit
62 Amplification unit
100 Frequency modulation unit
101 First laser oscillator
102 Second laser oscillator
103 Phase modulator
104 Multiplexing unit
105 Detection unit
110 Frequency modulation unit
111 First laser oscillator
112 Second laser oscillator
113 Phase modulator
114 Multiplexing unit
115 Detection unit
116 Amplification unit
300 Distribution unit
301 Amplification unit
302 First laser oscillator
303 Phase modulator
304 Second laser oscillator
305 Multiplexing unit
306 Detection unit

1. An optical transmission apparatus comprising:
a distribution unit configured to distribute a modulation signal to a plurality of amplification units connected in parallel;
a plurality of phase modulators which are connected in cascade to generate a phase-modulated optical signal in accordance with each modulation signal of which voltage is amplified by the plurality of the amplification units connected in parallel by using a laser beam based on a first oscillation frequency;
a multiplexing unit configured to multiplex a laser beam based on a second oscillation frequency and the optical signal; and
a detection unit configured to generate a frequency modulation signal by executing detection processing on a result of multiplexing the laser beam based on the second oscillation frequency and the optical signal.

2. An optical transmission method executed by an optical transmission apparatus, the method comprising:
a distribution step of distributing a modulation signal to a plurality of amplification units connected in parallel;
a plurality of phase modulation steps of generating a phase-modulated optical signal in accordance with each modulation signal of which voltage is amplified by the plurality of the amplification units connected in parallel using a laser beam based on a first oscillation frequency in a plurality of phase modulators connected in cascade;
a multiplexing step of multiplexing a laser beam based on a second oscillation frequency and the optical signal; and
a detection step of generating a frequency modulation signal by executing detection processing on a result of multiplexing the laser beam based on the second oscillation frequency and the optical signal.

3. An optical transmission system comprising an optical transmission apparatus, an optical line terminal, and an optical line end terminal, wherein the optical transmission apparatus comprises:
a distribution unit configured to distribute a modulation signal to a plurality of amplification units connected in parallel;
a plurality of phase modulators which are connected in cascade to generate a phase-modulated first optical signal in accordance with each modulation signal of which voltage is amplified by the plurality of amplification units connected in parallel by using a laser beam based on a first oscillation frequency;
a multiplexing unit configured to multiplex a laser beam based on a second oscillation frequency and the first optical signal;
a detection unit configured to generate a frequency modulation signal by executing detection processing on a result of multiplexing the laser beam based on the second oscillation frequency and the first optical signal; and
an intensity modulator configured to generate an intensity-modulated second optical signal by using a laser beam for transmission by executing intensity modulation in accordance with the frequency modulation signal,
wherein the optical line terminal transmits the intensity-modulated second optical signal, and
the optical line end terminal acquires the intensity-modulated second optical signal.
